(19) United States
(12) Patent Application Publication
(10) Pub. No.: US 2005/0259028 A1
(43) Pub. Date: Nov. 24, 2005

(54) Array antenna

(75) Inventors: Misa Koreyasu, Nishinomiya-city (JP); Tetsuya Takashima, Nishinomiya-City (JP); Katsufumi Hiraoka, Nishinomiya-City (JP); Akihiro Hino, Nishinomiya-City (JP)

Correspondence Address: BIRCH STEWART KOLASCH & BIRCH, PO BOX 747, FALLS CHURCH, VA, 22040-0747, US

(73) Assignee: FURUNO Electric Company Limited

(21) Appl. No.: 11/134,286

(22) Filed: May 23, 2005

(30) Foreign Application Priority Data
May 24, 2004 (JP) TOKUGAN2004-15359

(51) Int. Cl. H01Q 21/00

(52) U.S. Cl. 343/853; 343/700 MS

(57) ABSTRACT

Antenna elements are arranged in line on a surface of a substrate at specific intervals along a longitudinal direction of the substrate. A phase-inverting distributor is formed on the surface of the substrate in an area located between two antenna elements which are closest to and located on both sides of a vertical centerline, or a reference line, of the substrate. A primary feeder line formed along the longitudinal direction of the substrate extends from the phase-inverting distributor on both left and right sides thereof. The individual antenna elements are connected to the primary feeder line by secondary feeder lines having predetermined impedances. The secondary feeder lines are connected to the respective antenna elements on sides thereof which are perpendicular to the longitudinal direction of the substrate and face the reference line on which the phase-inverting distributor is located.

### BACKGROUND OF THE INVENTION

1. Field of the Invention

The present invention relates to an array antenna on which a plurality of antenna elements for radiating radio waves are arranged generally in line, forming a linear array.

2. Description of the Related Art

There exist various kinds of conventionally known array antennas employing a configuration in which a plurality of antenna elements are formed on a substrate and the individual antenna elements are connected to secondary feeder lines which are arranged parallel to one another.

FIG. 6 is a plan view generally showing the configuration of a conventional array antenna on which a plurality of antenna elements are arranged generally in line. This kind of conventional array antenna is shown in Japanese Patent Application Publication No. 1999-312909, in which antenna elements are arranged side by side as shown in FIG. 6.

Referring to FIG. 6, the array antenna includes a substrate 1 having a rectangular shape in plan view, multiple antenna elements 2a-2i formed on a surface of the substrate 1, secondary feeder lines 3a-3i connected respectively to the antenna elements 2a-2i, a primary feeder line 4 connected to the individual secondary feeder lines 3a-3i, and an outgoing line 5 of which one end is connected to the primary feeder line 4 and the other end is connected to an external circuit (not shown). The substrate 1 is made of a dielectric material while the antenna elements 2a-2i, the secondary feeder lines 3a-3i, the primary feeder line 4 and the outgoing line 5 are made of a patterned conductor layer formed on the surface of the substrate 1.

More specifically, the antenna elements 2a-2i are arranged on the substrate 1 generally in line along a longitudinal (horizontal as illustrated in FIG. 6) axis of the substrate 1 at specified equal intervals with long sides of the successive antenna elements 2a-2i placed side by side. The secondary feeder lines 3a-3i are connected to the respective antenna elements 2a-2i on the sides thereof (right sides as illustrated in FIG. 6) which are perpendicular to and face one direction along the longitudinal axis of the substrate 1. This arrangement is used to ensure that the antenna elements 2a-2i produce electric fields in the same direction and the individual secondary feeder lines 3a-3i have a specific impedance. The interval between the successive antenna elements 2a-2i is normally made equal to an integer multiple of the wavelength of radio waves such that the radio waves emitted from the antenna elements 2a-2i are synchronized in phase and radiation pattern of the array antenna is optimized.

In the aforementioned configuration, all of the antenna elements 2a-2i are arranged at regular intervals, whereby the array antenna radiates a high-intensity radio wave in a specified direction.

As shown in FIG. 6, the substrate 1 has an overall length Lpwb and the array antenna has a substantial antenna length Lant. In the aforementioned conventional array antenna, the secondary feeder lines 3a-3i are connected to the antenna elements 2a-2i on the sides thereof facing the same direction along the longitudinal axis of the substrate 1. It is therefore impossible to form antenna elements all the way from the proximity of one end of the substrate 1 to the proximity of the other end of the substrate 1 along the longitudinal axis thereof. As a result, the substantial antenna length Lant is shorter than the overall length Lpwb of the substrate 1, making it impossible to form the array antenna on the substrate 1 in an efficient fashion.

### SUMMARY OF THE INVENTION

In light of the foregoing, it is an object of the invention to provide an array antenna having desired directivity, in which antenna elements can be formed in a specific pattern on a substrate in an efficient way.

According to the invention, an array antenna includes a substrate, a plurality of antenna elements formed on a surface of the substrate in such a way that the antenna elements are arranged generally in a straight line, a plurality of secondary feeder lines individually connected to the antenna elements on sides thereof which are perpendicular to an arraying direction of the antenna elements, a primary feeder line to which the individual secondary feeder lines are connected parallel to one another, and a phase-inverting distributor inserted in the primary feeder line in an area located halfway along the length of the primary feeder line. In this array antenna of the invention, the sides of the antenna elements connected to the individual secondary feeder lines face a reference line which passes through the phase-inverting distributor perpendicular to the arraying direction of the antenna elements, the antenna elements are symmetrically arranged with respect to the reference line, and at least one of element-to-element intervals differs from the others.

In one feature of the invention, the primary feeder line and the secondary feeder lines are symmetrically arranged with respect to the aforementioned reference line. Alternatively, the phase-inverting distributor is located at a point of intersection of the aforementioned reference line and a second reference line passing through midpoints of the sides of the antenna elements which are parallel to the aforementioned reference line, the second reference line being perpendicular to the reference line, and the primary feeder line and the secondary feeder lines are symmetrically arranged with respect to the point of intersection of the reference line and the second reference line.

In the aforementioned configuration of the array antenna, the secondary feeder lines are connected to the respective antenna elements on the sides thereof facing the reference line on which the phase-inverting distributor is formed halfway along a longitudinal direction of the substrate. This means that sides of two antenna elements facing both longitudinal ends of the substrate are not connected to the secondary feeder lines. Thus, the antenna elements can be formed substantially all the way along the longitudinal direction of the substrate, from one longitudinal end thereof to the other. As will be later discussed in detail with reference to preferred embodiments of the invention, signals transmitted to the secondary feeder lines on left and right sides of the substrate are inverted in phase by the phase-inverting distributor. As a result, radio waves radiated from the antenna elements symmetrically arranged on the opposite sides of the reference line are not canceled out one another despite the fact that the secondary feeder lines supplies the signals to the antenna elements on the left and right sides of the substrate from opposite sides.

In the array antenna of the invention, one or more element-to-element intervals differ from the other element-to-element intervals as stated above. This means that the antenna elements can be arranged at desired intervals. This makes it possible to manufacture an array antenna having sharp directivity in a specific direction by properly determining the element-to-element intervals such that a desired radiation pattern (directivity) of the array antenna would be obtained as a result of mutual interference among the radio waves radiated from the individual antenna elements.

In another feature of the invention, conductor lines from the phase-inverting distributor to the individual antenna elements have varying impedances on each side of the reference line, each of the conductor lines including a portion of the primary feeder line and one of the secondary feeder lines.

In this array antenna of the invention, the conductor lines from the phase-inverting distributor to the individual antenna elements have varying impedances on each side of the reference line. This is equivalent to an array antenna configuration in which attenuators having varying amounts of attenuation are inserted in the conductor lines connected to the individual antenna elements. In this configuration, the individual antenna elements emit radio waves at intensities varying from one antenna element to next on each side of the reference line so that desired directivity is obtained as a result of mutual interference among the radio waves radiated from the individual antenna elements.

In still another feature of the invention, the interval between only those two antenna elements which are closest to the phase-inverting distributor differs from the interval between any two adjacent antenna elements.

Since the element-to-element interval differs only at a mid-length position of the substrate where the phase-inverting distributor is located according to this feature of the invention, the array antenna can be produced with a simple configuration by forming the antenna elements in a simplified arrangement pattern.

These and other objects, features and advantages of the invention will become more apparent upon reading the following detailed description in conjunction with the accompanying drawings.

### BRIEF DESCRIPTION OF THE DRAWINGS

FIG. 1 is a plan view generally showing the configuration of an array antenna according to a first embodiment of the invention;

FIG. 2 is a conceptual diagram showing in which direction electric fields produced by individual antenna elements are oriented;

FIG. 3 is a diagram showing a horizontal radiation pattern formed by the array antenna of the first embodiment;

FIG. 4 is a diagram showing a horizontal radiation pattern formed by an array antenna of a second embodiment;

FIG. 5 is a plan view generally showing the configuration of an array antenna according to a third embodiment of the invention; and

FIG. 6 is a plan view generally showing the configuration of a conventional array antenna.

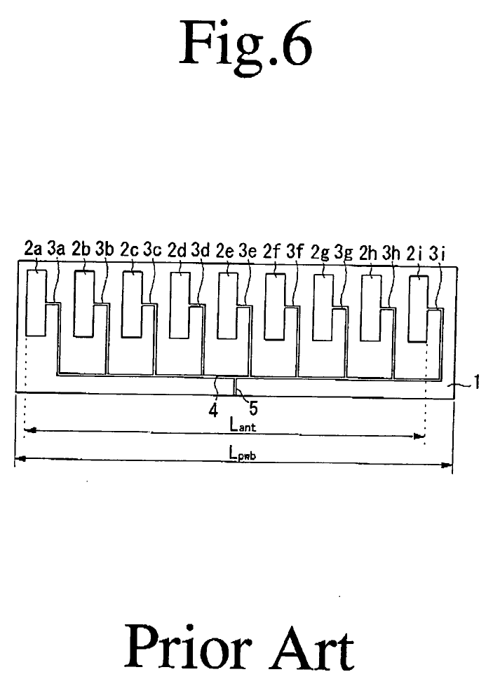

### DETAILED DESCRIPTION OF THE PREFERRED EMBODIMENTS OF THE INVENTION

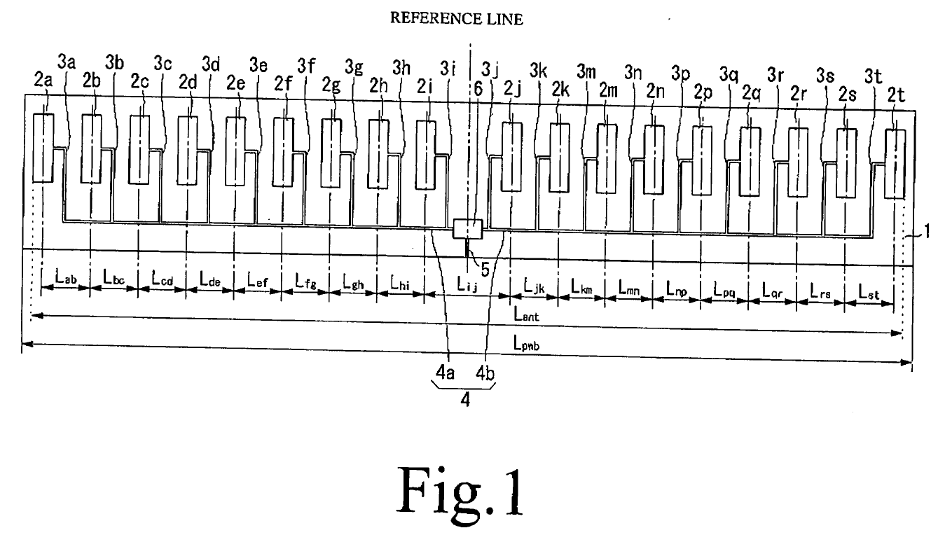

An array antenna according to a first embodiment of the invention is now described with reference to FIGS. 1 to 3 and Tables 1 and 2.

FIG. 1 is a plan view generally showing the configuration of the array antenna according to the first embodiment of the invention. Referring to FIG. 1, the array antenna includes a substrate 1 having a rectangular shape in plan view and a plurality of antenna elements 2a-2t formed on a surface of the substrate 1, the antenna elements 2a-2t being arranged in a predetermined array pattern. The array antenna further includes a plurality of secondary feeder lines 3a-3t, a primary feeder line 4, an outgoing line 5 and a phase-inverting distributor 6 which are also formed on the surface of the substrate 1. The substrate 1 is made of a dielectric material while the antenna elements 2a-2t, the secondary feeder lines 3a-3t, the primary feeder line 4 and the outgoing line 5 are made of a patterned conductor layer (including conductor lines and electrodes) formed on the surface of the substrate 1. The phase-inverting distributor 6 is made of a specific pattern of conductor formed in a joint area between the primary feeder line 4 and the outgoing line 5, the phase-inverting distributor 6 including a signal distribution circuit and a phase-inverting circuit, for example.

The antenna elements 2a-2t each have a rectangular shape in plan view and are formed in such a fashion that long sides of the antenna elements 2a-2t are aligned parallel to short sides of the substrate 1 and short sides of the antenna elements 2a-2t are aligned parallel to long sides of the substrate 1. These antenna elements 2a-2t formed on the substrate 1 are arranged at specified intervals along a longitudinal direction of the substrate 1 (parallel to the long sides of the substrate 1). The phase-inverting distributor 6 is formed in an area located generally on a vertical centerline, or a “reference line” passing between the antenna element 2i and the antenna element 2j shown by an alternate long and short dashed line in FIG. 1, the location of the phase-inverting distributor 6 being separated from an area where the antenna elements 2a-2t are arranged on the substrate 1 by a specific distance in a short side direction of the substrate 1.

The primary feeder line 4 is formed in a linear pattern extending leftward and rightward from the phase-inverting distributor 6 along the longitudinal direction of the substrate 1, that is, the direction in which the antenna elements 2a-2t are arrayed. Thus, as can be seen from FIG. 1, the primary feeder line 4 includes a first primary feeder line portion 4a extending leftward along the antenna elements 2a-2i and a second primary feeder line portion 4b extending rightward along the antenna elements 2j-2t.

The antenna elements 2a-2i are connected to the first primary feeder line portion 4a by the secondary feeder lines 3a-3i, respectively. As depicted in FIG. 1, upper ends of these secondary feeder lines 3a-3i are connected to the respective antenna elements 2a-2i on the long sides thereof which are perpendicular to the arraying direction of the antenna elements 2a-2i and face the aforementioned reference line on which the phase-inverting distributor 6 is located. Each of the secondary feeder lines 3a-3i is generally L-shaped, having a horizontal portion extending for a specific distance along the arraying direction of the antenna elements 2a-2t, or along the longitudinal direction of the substrate 1, and a vertical portion extending from one end of the horizontal portion perpendicular to the first primary feeder line portion 4a, or parallel to the short sides of the substrate 1. The vertical portion of each of the secondary feeder lines 3a-3i is connected to the first primary feeder line portion 4a.

Similarly, the antenna elements 2j-2t are connected to the second primary feeder line portion 4b by the secondary feeder lines 3j-3t, respectively. As depicted in FIG. 1, upper ends of these secondary feeder lines 3j-3t are connected to the respective antenna elements 2j-2t on the long sides thereof which are perpendicular to the arraying direction of the antenna elements 2j-2t and face the aforementioned reference line on which the phase-inverting distributor 6 is located. Each of the secondary feeder lines 3j-3t is generally L-shaped, having a horizontal portion extending for the specific distance along the arraying direction of the antenna elements 2j-2t, or along the longitudinal direction of the substrate 1, and a vertical portion extending from one end of the horizontal portion perpendicular to the second primary feeder line portion 4b, or parallel to the short sides of the substrate 1.

The array antenna of the present embodiment thus structured has a bilaterally symmetrical configuration with respect to aforementioned reference line on which the phase-inverting distributor 6 is located, the reference line being perpendicular to the arraying direction of the antenna elements 2j-2t. More specifically, the array antenna has a pattern of electrodes and conductor lines forming the antenna elements 2a-2i, the secondary feeder lines 3a-3i and the first primary feeder line portion 4a on one side (left side as illustrated) of the reference line as well as a pattern of electrodes and conductor lines forming the antenna elements 2j-2t, the secondary feeder lines 3j-3t and the second primary feeder line portion 4b on the other side (right side as illustrated) of the reference line.

The phase-inverting distributor 6 distributes a signal fed through the outgoing line 5 to the first primary feeder line portion 4a and the second primary feeder line portion 4b with small loss with the signal transmitted to one of the primary feeder line portions 4a, 4b inverted in phase. Specifically, the phase of the signal transmitted to the second primary feeder line portion 4b is advanced or delayed by π radians with respect to the phase of the signal transmitted to the first primary feeder line portion 4a, for example.

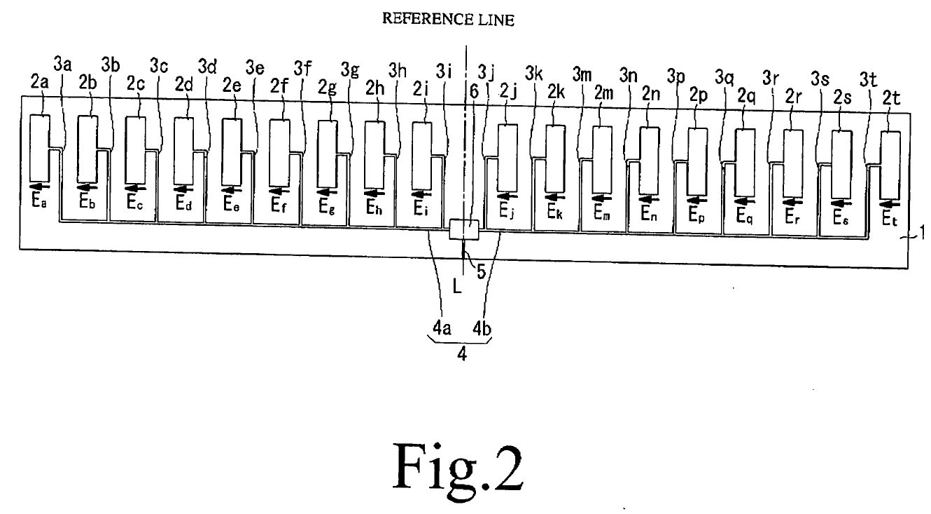

FIG. 2 is a conceptual diagram showing in which direction electric fields Ea-Et produced by the individual antenna elements 2a-2t are oriented. Since the phase-inverting distributor 6 distributes the input signal to the first primary feeder line portion 4a and the second primary feeder line portion 4b in the aforementioned manner, the electric fields Ea-Et produced by the individual antenna elements 2a-2t align in the same direction as illustrated.

Consequently, radio waves emitted from the antenna elements 2a-2i and the antenna elements 2j-2t which are symmetrically arranged on opposite sides of the reference line passing at right angles to the arraying direction of the antenna elements 2a-2t (FIG. 1) are not canceled out one another and, thus, the array antenna radiates radio waves having desired directivity.

Here, the successive antenna elements 2a-2t are arranged at intervals (element-to-element distances) shown in FIG. 1. Specifically, the interval between the antenna elements 2a and 2b is Lab, the interval between the antenna elements 2b and 2c is Lbc, the interval between the antenna elements 2c and 2d is Lcd, the interval between the antenna elements 2d and 2e is Lde, the interval between the antenna elements 2e and 2f is Lef, the interval between the antenna elements 2f and 2g is Lfg, the interval between the antenna elements 2g and 2h is Lgh, the interval between the antenna elements 2h and 2i is Lhi, the interval between the antenna elements 2i and 2j is Lij, the interval between the antenna elements 2j and 2k is Ljk, the interval between the antenna elements 2k and 2m is Lkm, the interval between the antenna elements 2m and 2n is Lmn, the interval between the antenna elements 2n and 2p is Lnp, the interval between the antenna elements 2p and 2q is Lpq, the interval between the antenna elements 2q and 2r is Lqr, the interval between the antenna elements 2r and 2s is Lrs, the interval between the antenna elements 2s and 2t is Lst. In this embodiment, only the interval Lij between the antenna elements 2i and 2j differs from the other intervals Lab-Lhi, Ljk-Lst as shown in Table 1. These element-to-element intervals are set such that the radio waves emitted from all of the antenna elements 2a-2t create a specific radiation pattern.

On the other hand, the secondary feeder lines 3a-3t have varying impedances so that the individual secondary feeder lines 3a-3t have predetermined amounts of attenuation as shown in Table 2. To achieve this, the secondary feeder lines 3a-3t are formed of conductor lines having specific thicknesses and widths, or impedance elements, such as resistors, are series-connected midway in the secondary feeder lines 3a-3t as appropriate.

Table 1 shows set values of the aforementioned element-to-element intervals Lab-Lst, and Table 2 shows the amounts of attenuation from the phase-inverting distributor 6 to the individual antenna elements 2a-2t including attenuation in the primary feeder line 4 and the respective secondary feeder lines 3a-3t.

TABLE 1

| Symbol | Element-to-element interval (mm) |
|---|---|
| Lab | 21.65 |
| Lbc | 21.65 |
| Lcd | 21.65 |
| Lde | 21.65 |
| Lef | 21.65 |
| Lfg | 21.65 |
| Lgh | 21.65 |
| Lhi | 21.65 |
| Lij | 25.65 |
| Ljk | 21.65 |
| Lkm | 21.65 |
| Lmn | 21.65 |
| Lnp | 21.65 |
| Lpq | 21.65 |
| Lqr | 21.65 |
| Lrs | 21.65 |
| Lst | 21.65 |

TABLE 2

| Antenna element | Amount of attenuation (dB) |
|---|---|
| 2a | −10.48 |
| 2b | −10.72 |
| 2c | −7.71 |
| 2d | −5.34 |
| 2e | −3.48 |
| 2f | −2.05 |
| 2g | −1.01 |
| 2h | −0.33 |
| 2i | 0.00 |
| 2j | 0.00 |
| 2k | −0.33 |
| 2m | −1.01 |
| 2n | −2.05 |
| 2p | −3.48 |
| 2q | −5.34 |
| 3r | −7.71 |
| 2s | −10.72 |
| 2t | −10.48 |

As shown in Table 1, only the interval Lij between the antenna elements 2i and 2j differs from the other element-to-element intervals Lab-Lhi, Ljk-Lst in the array antenna of this embodiment.

Also, as shown in Table 2, conductor lines (including portions of the primary feeder line and the secondary feeder lines) connected to any two antenna elements located at symmetrical positions with respect to the aforementioned reference line have the same amount of attenuation, and the amounts of attenuation in these conductor lines increase with the distance from the phase-inverting distributor 6 to each successive antenna element in the array antenna of this embodiment.

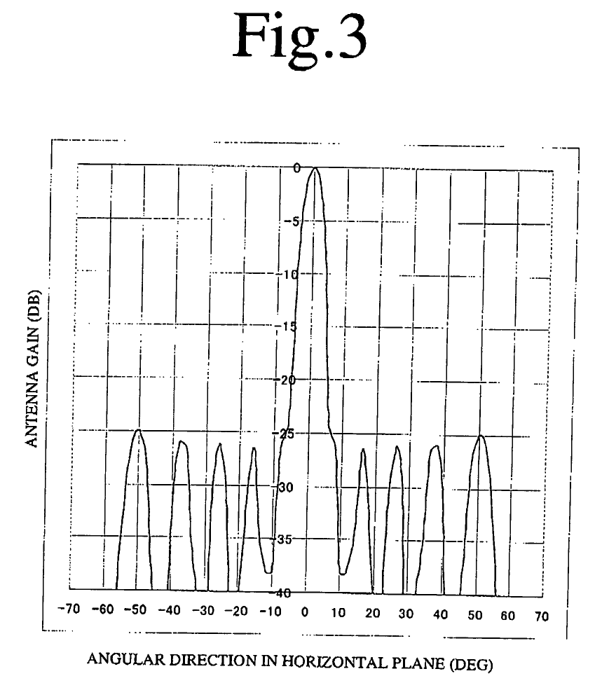

FIG. 3 is a diagram showing a horizontal radiation pattern formed by the array antenna of the first embodiment. The array antenna configured as explained above exhibits horizontal radiation characteristics as depicted in FIG. 3.

As thus far discussed, only the interval Lij between the antenna elements 2i and 2j closest to the phase-inverting distributor 6 is made different from the other element-to-element intervals Lab-Lhi, Ljk-Lst and the amounts of attenuation in the conductor lines from the phase-inverting distributor 6 to the individual antenna elements 2a-2t are set to predetermined values in the array antenna of the first embodiment. According to this arrangement of the embodiment, it is possible to produce an array antenna having sharp directivity with a simple configuration, in which a large proportion of radio wave energy is radiated in approximately a central direction in a horizontal plane, perpendicular to a radiating surface of the array antenna, as shown in FIG. 3.

As shown in FIG. 1, the substrate 1 has an overall length Lpwb and the array antenna has a substantial antenna length Lant. In the above-described configuration of the array antenna of the embodiment, the antenna elements 2a-2t are formed all the way from the proximity of one end of the substrate 1 to the proximity of the other end of the substrate 1 along the longitudinal direction thereof, so that the antenna elements 2a-2t can be arranged on the substrate 1 in an efficient fashion and the substantial antenna length Lant can be made as large as possible relative to the overall length Lpwb of the substrate 1.

Furthermore, it is possible to obtain desired radiation characteristics by properly setting the amounts of attenuation for the individual secondary feeder lines 3a-3t. This means that an array antenna having the desired radiation characteristics (directivity) can be produced in an efficient way by using the substrate 1 having a given shape. Additionally, as the interval Lij between the antenna elements 2i and 2j at a central position of the substrate 1 along the arraying direction of the antenna elements 2a-2t, or the interval Lij between the antenna elements 2i and 2j closest to the phase-inverting distributor 6, is made different from the other element-to-element intervals Lab-Lhi, Ljk-Lst, the array antenna is obtained with a simplified antenna element arrangement pattern.

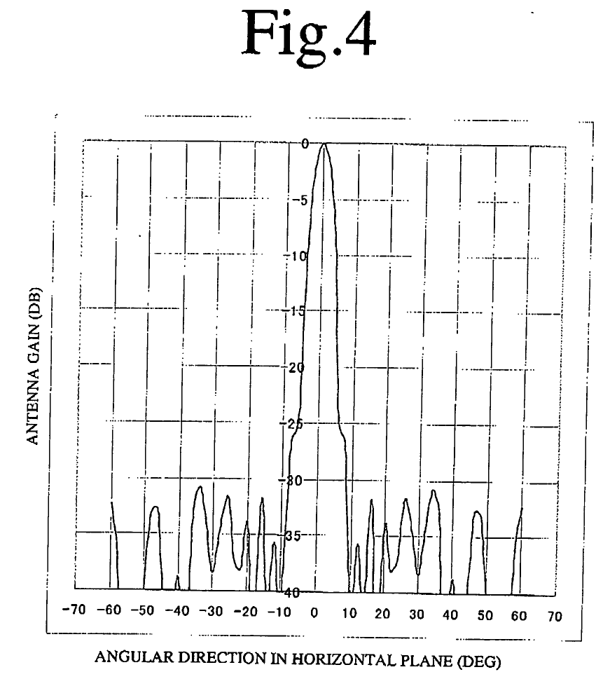

An array antenna according to a second embodiment of the invention is now described with reference to FIG. 4 and Tables 3 and 4.

The array antenna of the second embodiment has basically the same configuration as the array antenna of the first embodiment (refer to FIG. 1) except that the intervals between the successive antenna elements 2a-2t and the amounts of attenuation in the individual antenna elements 2a-2t in the array antenna of the second embodiment are varied from those of the first embodiment.

Table 1 shows the intervals Lab-Lst between the successive antenna elements 2a-2t, and Table 2 shows the amounts of attenuation from the phase-inverting distributor 6 to the individual antenna elements 2a-2t including attenuation in the primary feeder line 4 and the respective secondary feeder lines 3a-3t.

TABLE 3

| Symbol | Element-to-element interval (mm) |
|---|---|
| Lab | 25.65 |
| Lbc | 23.40 |
| Lcd | 21.90 |
| Lde | 21.65 |
| Lef | 21.75 |
| Lfg | 21.65 |
| Lgh | 22.15 |
| Lhi | 23.50 |
| Lij | 25.65 |
| Ljk | 23.50 |
| Lkm | 22.15 |
| Lmn | 21.65 |
| Lnp | 21.75 |
| Lpq | 21.65 |
| Lqr | 21.90 |
| Lrs | 23.40 |
| Lst | 25.65 |

TABLE 4

| Antenna element | Amount of attenuation (dB) |
|---|---|
| 2a | −13.58 |
| 2b | −9.88 |
| 2c | −7.81 |
| 2d | −6.52 |
| 2e | −3.72 |
| 2f | −2.67 |
| 2g | −2.19 |
| 2h | −0.61 |
| 2i | 0.00 |
| 2j | 0.00 |
| 2k | −0.61 |
| 2m | −2.19 |
| 2n | −2.67 |
| 2p | −3.72 |
| 2q | −6.52 |
| 3r | −7.81 |
| 2s | −9.88 |
| 2t | −13.58 |

As shown in Table 3, the interval Lab between the antenna elements 2a and 2b is equal to the interval Lst between the antenna elements 2s and 2t (Lab=Lst), the interval Lbc between the antenna elements 2b and 2c is equal to the interval Lrs between the antenna elements 2r and 2s (Lbc=Lrs), the interval Lcd between the antenna elements 2c and 2d is equal to the interval Lqr between the antenna elements 2q and 2r (Lcd=Lqr), the interval Lde between the antenna elements 2d and 2e is equal to the interval Lpq between the antenna elements 2p and 2q (Lpq=Lpq), the interval Lef between the antenna elements 2e and 2f is equal to the interval Lnp between the antenna elements 2n and 2p (Lef=Lnp), the interval Lfg between the antenna elements 2f and 2g is equal to the interval Lmn between the antenna elements 2m and 2n (Lfg=Lmn), the interval Lgh between the antenna elements 2g and 2h is equal to the interval Lkm between the antenna elements 2k and 2m (Lgh=Lkm), and the interval Lhi between the antenna elements 2h and 2i is equal to the interval Ljk between the antenna elements 2j and 2k (Lhi=Ljk). While the element-to-element intervals at any two symmetrical points with respect to the reference line passing through the phase-inverting distributor 6 are equal to each other as stated above, the interval Lij between the antenna elements 2i and 2j and the aforementioned element-to-element intervals on each side of the reference line are not necessarily equal to one another but are made unequal in this embodiment as indicated in Table 3.

Also, as shown in Table 4, conductor lines (including portions of the primary feeder line and the secondary feeder lines) connected to any two antenna elements located at symmetrical positions with respect to the aforementioned reference line have the same amount of attenuation, and the amounts of attenuation in these conductor lines increase with the distance from the phase-inverting distributor 6 to each successive antenna element in the array antenna of this embodiment.

FIG. 4 is a diagram showing a horizontal radiation pattern formed by the array antenna of the second embodiment. The array antenna configured as explained above exhibits horizontal radiation characteristics as depicted in FIG. 4.

With the aforementioned configuration of the second embodiment, it is possible to produce an array antenna having much sharper directivity (FIG. 4) than shown in FIG. 3. As can be seen from a comparison between the radiation patterns of FIGS. 3 and 4, a significantly larger proportion of radio wave energy is radiated in approximately the central direction in the horizontal plane, perpendicular to the radiating surface of the array antenna, in the second embodiment than in the first embodiment.

The configuration of the second embodiment makes it possible to properly set the element-to-element intervals as well as the amounts of attenuation for the individual secondary feeder lines 3a-3t, so that a desired radiation pattern can be obtained from a wider range of radiation characteristics. In other words, an array antenna having the desired radiation characteristics (directivity) can be produced in an efficient way by setting the radiation characteristics within a wider range using the substrate 1 having a given shape. Furthermore, since the antenna elements 2a-2t can be arranged with more degrees of freedom in the second embodiment than in the first embodiment, it is possible to produce an array antenna having more optimized radiation characteristics.

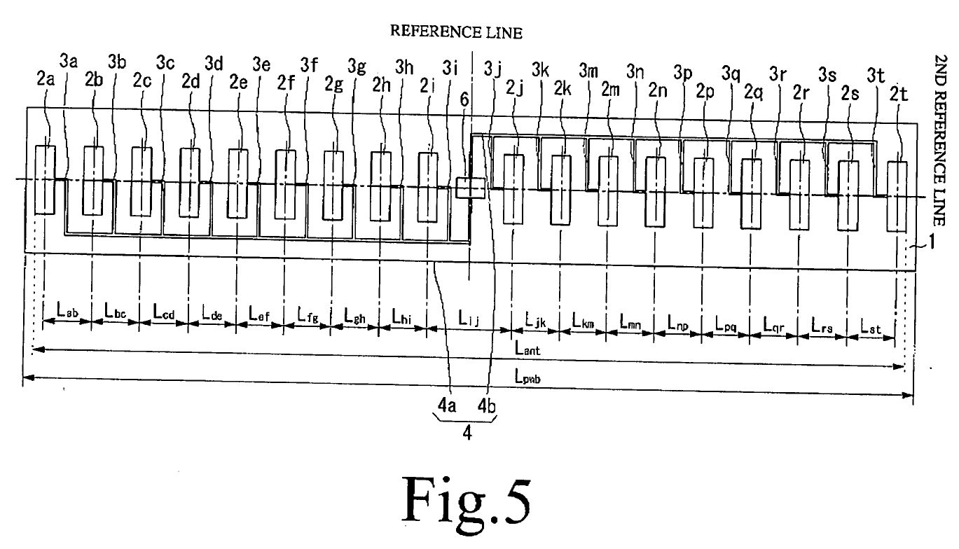

FIG. 5 is a plan view generally showing the configuration of an array antenna according to a third embodiment of the invention. While the antenna elements 2a-2i and 2j-2t, the primary feeder line portions 4a and 4b, and the secondary feeder lines 3a-3i and 3j-3t are symmetrically arranged with respect to the reference line which passes through the phase-inverting distributor 6 at right angles to the arraying direction of the antenna elements 2a-2t in the foregoing first and second embodiments, this arrangement may be modified as shown in FIG. 5. Specifically, in the array antenna of the third embodiment, the phase-inverting distributor 6 is located at a point of intersection of the aforementioned reference line and a second reference line passing through midpoints of the long sides of the antenna elements 2a-2t which are parallel to the reference line, and the primary feeder line portions 4a, 4b and the secondary feeder lines 3a-3i, 3j-3t are symmetrically arranged with respect to the point of intersection of the reference line and the second reference line (point symmetry) as illustrated in FIG. 5. The array antenna thus configured exhibits the same advantageous effects as discussed above with reference to the first and second embodiments.

While the array antennas of the foregoing embodiments are provided with 18 antenna elements each, the embodiments may be modified such that the array antenna is provided with any desired number of antenna elements according to required radiation characteristics and technical specifications of an apparatus for which the array antenna is used.

Furthermore, although the phase-inverting distributor 6 is formed in the area located generally on the reference line (vertical centerline) passing through a midpoint along the arraying direction of the antenna elements 2a-2t in the foregoing embodiments, the phase-inverting distributor 6 may be formed in any area selected along the arraying direction of the antenna elements 2a-2t according to required radiation characteristics.

Moreover, while the impedances of the secondary feeder lines 3a-3t are individually set such that the impedance of the conductor line from the phase-inverting distributor 6 to each of the antenna elements 2a-2t varies in a desired fashion in the foregoing embodiments, the impedance of the conductor line from the phase-inverting distributor 6 to each of the antenna elements 2a-2t may be varied by setting the impedance of a length of the primary feeder line 4 from the phase-inverting distributor 6 to a connecting point between the primary feeder line 4 and each of the secondary feeder lines 3a-3t to a desired value.

1. An array antenna comprising:
a substrate;
a plurality of antenna elements formed on a surface of the substrate in such a way that the antenna elements are arranged generally in a straight line;
a plurality of secondary feeder lines individually connected to the antenna elements on sides thereof which are perpendicular to an arraying direction of the antenna elements;
a primary feeder line to which the individual secondary feeder lines are connected parallel to one another; and
a phase-inverting distributor inserted in the primary feeder line in an area located halfway along the length of the primary feeder line;
wherein the sides of the antenna elements connected to the individual secondary feeder lines face a reference line which passes through the phase-inverting distributor perpendicular to the arraying direction of the antenna elements; and
wherein the antenna elements are symmetrically arranged with respect to said reference line, and at least one of element-to-element intervals differs from the others.

2. The array antenna according to claim 1, wherein the primary feeder line and the secondary feeder lines are symmetrically arranged with respect to said reference line.

3. The array antenna according to claim 1, wherein the phase-inverting distributor is located at a point of intersection of said reference line and a second reference line passing through midpoints of the sides of the antenna elements which are parallel to said reference line, said second reference line being perpendicular to said reference line, and the primary feeder line and the secondary feeder lines are symmetrically arranged with respect to the point of intersection of said reference line and said second reference line.

4. The array antenna according to one of claims 1 to 3, wherein conductor lines from the phase-inverting distributor to the individual antenna elements have varying impedances on each side of said reference line, each of the conductor lines including a portion of the primary feeder line and one of the secondary feeder lines.

5. The array antenna according to one of claims 1 to 4, wherein the interval between only those two antenna elements which are closest to the phase-inverting distributor differs from the interval between any two adjacent antenna elements.
